(19) United States
(12) Patent Application Publication
(10) Pub. No.: US 2018/0161673 A1
(43) Pub. Date: Jun. 14, 2018

(54) USING TELEMETRY DATA IN A DISTRIBUTED COMPUTING ENVIRONMENT TO ADDRESS COMPLEX PROBLEMS

(71) Applicant: Microsoft Technology Licensing, LLC, Redmond, WA (US)

(72) Inventors: Ethan Pasternack, Kent, WA (US); Derek T. Dutilly, Snoqualmie, WA (US); Kevin Lambert, Redmond, WA (US); William N. Frost, Bothell, WA (US); Jason McCullough, Seattle, WA (US); Tristan C. Hall, Seattle, WA (US)

(73) Assignee: Microsoft Technology Licensing, LLC, Redmond, WA (US)

(21) Appl. No.: 15/377,988

(22) Filed: Dec. 13, 2016

(51) Int. Cl. A63F 13/35; H04L 29/08; H04Q 9/00; A63F 13/67

(52) U.S. Cl. CPC A63F 13/35; A63F 13/67; H04Q 9/00; H04L 67/125

(57) ABSTRACT

The disclosed technology concerns methods, apparatus, and systems for using telemetry data from a large number of remote computing devices to address complex problems otherwise prone to subjective inaccuracies. Particular embodiments disclosed herein involve classifying the difficulty of solving (or completing) an objective presented by a certain item of digital content. For instance, certain example embodiments involve collecting telemetry data from hundreds or thousands of users engaging with a respective content item, and, based at least in part on that telemetry data, assigning a difficulty classification to the content item.

### FIELD

This application relates generally to using telemetry data in a distributed computing environment to address complex problems otherwise prone to subjective inaccuracies.

### BACKGROUND

Household computing devices (such as mobile devices, PCs, laptops, tablet computer, gaming consoles, and the like) are increasingly used as part of a networked system in which the devices communicate with a central server. The central server can provide numerous services to the devices. For instance, services provided by the central server can help facilitate more interactive and user-customized experiences. To date, however, most services provided by a central service rely on subjective decisions made by one or a small number of developers or make only limited use of a single user's data. Such approaches fail to meaningfully and effectively utilize the vast amount of telemetry data available to the central service through its communications with a large number of remote computing devices. As described in detail below, a distributed network-based approach that collects large amounts of telemetry data can be used to address highly complex problems that are prone to subjective inaccuracies.

### SUMMARY

The disclosed technology concerns methods, apparatus, and systems for using telemetry data from a large number of remote computing devices to address complex problems otherwise prone to subjective inaccuracies. The disclosed methods, apparatus, and systems should not be construed as limiting in any way. Instead, the present disclosure is directed toward all novel and nonobvious features and aspects of the various disclosed embodiments, alone or in various combinations and subcombinations with one another.

Particular embodiments disclosed herein involve classifying the difficulty of solving (or completing) an objective presented by a certain item of digital content. For instance, certain example embodiments involve collecting telemetry data from hundreds or thousands of users engaging with a respective content item, and, based at least in part on that telemetry data, assigning a difficulty classification to the content item.

As more fully explained below, certain embodiments involve a central service that sends out one or more specific initial states for a digital content item (via a seed or some other method) to a set of remote computing devices operated by various different users for evaluation (e.g., 500, 1,000, 2,500, or any other suitably large number of users per initial state). The digital content item can be, for example, a game application that begins in the specified initial state and proceeds deterministically toward an objective based only on selections made by the user (e.g., solitaire-style games). Interaction with the digital content can proceed until the user either completes the objective, decides to quit the application, and/or reaches a point where no further progress is possible. In particular embodiments, telemetry data is collected at the remote computing devices and transmitted to the central service. The telemetry data can include an array of data, including data indicative of progress by the user toward the objective, solvability of the specified initial state, play patterns, time to finish, moves to finish, and the like. The telemetry data can be aggregated and analyzed at the central service in order to determine various aspects of the one or more specified initial states. In particular embodiments, one or more metrics can be computed that indicate the overall difficulty, respectively, of the one or more initial states. Rules can then be applied to the one or more metrics that classify the initial states into respective difficulty classifications, such as easy, medium, hard, expert. The initial states (e.g., seeds) can then be collated into an accumulated database and served back to remote users (e.g., via a user interface that allows users to choose the difficulty of the content they desire).

The innovations can be implemented as part of a method, as part of a computing system configured to perform the method, or as part of computer-readable media storing computer-executable instructions for causing a processing device (e.g., a circuit, such as a microprocessor or microcontroller), when programmed thereby, to perform the method. The various innovations can be used in combination or separately.

The foregoing and other objects, features, and advantages of the disclosed technology will become more apparent from the following detailed description, which proceeds with reference to the accompanying figures.

### BRIEF DESCRIPTION OF THE FIGURES

FIG. 1 is a schematic block diagram of an example networked environment in which embodiments of the disclosed technology can be implemented.

FIG. 2 illustrates a generalized example of a suitable computer system in which the described innovations may be implemented.

FIG. 3 is a block diagram illustrating an example set of telemetry data collected for ten different plays of a game having a common initial state.

FIGS. 4-9 are block diagrams of example data structures showing various metrics that can be used in embodiments of the disclosed technology.

FIG. 10 shows an example classification table as can be used in embodiments of the disclosed technology.

FIG. 11 is a block diagram illustrating an example data structure that applies the classification table of FIG. 10.

FIG. 12 is a schematic block diagram illustrating one example difficulty selection screen as may be presented to a user and which controls the interaction with a central server.

FIGS. 13-15 show example flow charts for using telemetry data in accordance with embodiments of the disclosed technology.

### DETAILED DESCRIPTION

### I. General Considerations

The present disclosure is directed toward all novel and nonobvious features and aspects of the various disclosed embodiments, alone or in various combinations and subcombinations with one another. Furthermore, any features or aspects of the disclosed embodiments can be used in various combinations and subcombinations with one another. For example, one or more method acts from one embodiment can be used with one or more method acts from another embodiment and vice versa. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the figures may not show the various ways in which the disclosed methods can be used in conjunction with other methods.

Various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

As used in this application and in the claims, the singular forms “a,” “an,” and “the” include the plural forms unless the context clearly dictates otherwise. Additionally, the term “includes” means “comprises.” Further, as used herein, the term “and/or” means any one item or combination of any items in the phrase.

### II. Introduction to the Disclosed Technology

There exist certain games, puzzles, or interactive scenarios whose structure can be characterized as beginning at one of a possible number of initial states (sometimes randomly generated) and that proceed from the initial state to an end point based on a user selecting one or more “moves” or “transitions” from the initial state to the end point in accordance with a set of rules and without any mid-game modifications to the game elements or rules being made. Accordingly, such games, puzzles, or interactive scenarios are “deterministic” in the sense that, once the initial state has been selected, the game, puzzle, or scenario proceeds according to user selection alone. The end point can be successful completion of the objective of the game, puzzle, or scenario; or can be failing to complete the objective (which may occur, for example, by the player quitting or by reaching a state in the game where no further possible moves are available or no further progress toward the objective is possible).

For many such games, puzzles, or scenarios, some initial states do not allow for successful completion to the desired solution state, regardless of user inputs. For example, in the well-known game Klondike Solitaire, it is estimated that around 15% of all possible initial states (corresponding to a particular “shuffle” of a 52 card deck) allow a player to reach the desired solution state (all cards being placed on the foundation and ordered by suit in succession from Ace to King) and are thus said to be “solvable”. Still further, even for those initial states that do allow for successful completion of the game, the likelihood of successfully reaching completion may vary greatly. As an example, and again with reference to Klondike Solitaire, some “solvable” initial states will only be solved by only a small fraction of players (e.g., <10%) whereas others will be solved by a large fraction of players (>80%), thus indicating the existence of a range of difficulties for any given initial state.

Notably, however, determining and categorizing the difficulty for any given initial state is exceedingly difficult and effectively impossible for humans without the aid of a computer-based and distributed internet-centric solution. For instance, the skill of a particular player will vary greatly, making it imprecise to have one user or some small sample group of users (e.g., less than 10, or less than 100) test initial states and assign subjective difficulty rankings to the initial state. Further, any approach that uses a computer to algorithmically play the game, puzzle, or scenario from an initial state will not accurately represent the widely varying and subjective actions made by the typical human player, and thus will be imprecise and unreliable in any resulting difficulty categorization. Still further, the number of possible initial states is typically so large as to make it unfeasible for a single person, a single computer simulator, or a small group of persons to categorize the difficulty of the initial states.

As an example, for any initial-state-based deterministic game as described above whose initial state is represented by a particular “shuffle” of a standard 52-card deck, the number of possible initial states is 52! (52 factorial) or 52×51×50× . . . 2×1. This number corresponds to about 8.06581752×10⁶⁷). More precisely, and written out, the number of possible initial states upon shuffling a 52-card deck (52!) is:
80,658,175,170,943,878,571,660,636,856,403,766,975, 289,505,440,883,277,824,000,000,000,000

This number is so large that it is actually many factors larger than the number of atoms in the world (see http://www.fnal.gov/pub/science/inquiring/questions/atoms.html). Consequently, the problems solved by the particular solutions described herein are problems suitable only for a distributed computing environment and cannot be performed as mere mental acts or by pencil and paper.

Additionally, any approach that uses a computer to algorithmically play the game, puzzle, or scenario from an initial state would use enormous amounts of dedicated computing, memory, and power resources during the computer's effort to categorize difficulty for the possible seeds in any useful time frame.

To address the computational and computer resource challenges described above, example embodiments disclosed herein employ an internet-centric distributed computing approach that not only reflects subjective user behavior but also greatly reduces the computational, memory, and power burden that would otherwise be needed.

For illustrative purposes, the example embodiments disclosed below will often refer to Klondike Solitaire as a representative application or game with which the disclosed technology can be used. This usage, however, is not to be construed as limiting in any way, however, as numerous other games/puzzles/scenarios exist that can use the disclosed technology. These other applications include, without limitation, FreeCell Solitaire (a card game), Spider Solitaire (a card game), Pyramid Solitaire (a card game), TriPeaks Solitaire (a card game), Mahjong Solitaire (a tile-matching game), Minesweeper (a puzzle game), Bridge (a card game), Chess (a game with pieces), Jigsaw, Sudoku, various other “causal games” that start from an initial state or level setting (e.g., Candy Crush, Bejeweled, etc.), or any other deterministic initial-state-based game/puzzle/scenario.

In the example of Klondike Solitaire, the initial state of Klondike Solitaire is a shuffled arrangement of cards in a virtual deck. The virtual cards are arranged into seven piles of cards, which together form the tableau and which can be built on in descending card value (where an Ace is considered a “1”) with alternating suit colors. In particular, the first pile (from left-to-right) has one card, the second has two, the third has three, the fourth has four, the fifth has five, the sixth has six, and the seventh has seven. Further, the top card of each pile is upturned and the remainder of the cards are downturned. The intermediate states of the game are transformations of the initial state brought about by player interactions that are deemed valid by the rules of Klondike Solitaire (see, e.g., http://en.wikipedia.org/wiki/Klondike_(solitaire)). One such possible interaction may be the filling of one of the piles with a stack of cards from King to some lower value (e.g., 2 or A or some other value). The desired solution state for Klondike Solitaire is reached when the player, following the rules of the game, moves cards from the tableau onto the foundation, which comprises four “foundation” piles of cards, each ordered successively in ascending value (from Ace to King) and having the same suit (such that cards in a given foundation pile are of the same suit).

Again, Klondike Solitaire is used for example purposes only. Numerous other games/puzzles/scenarios exist that can use the disclosed technology.

As another example, for instance, the technology can be used in a system in which mathematical problems or test questions from a huge database of such are distributed to remote computing devices to a program that selects questions/problems (e.g., randomly) from the database in a particular subject for students to practice. The telemetry of tens of thousands of students' efforts on each problem could allow a central server to use a set of developer-defined metrics (like time to complete, completion rate, user grade level, and/or even ancillary characteristics like student geographic region, student language, student disciplinary rating, etc) to classify each problem as “easy”, “medium”, “hard”, or “expert” for each grade level and/or ancillary classification. The resulting data could then be used to create standardized tests that are both randomized and fair while serving questions to each student that the student has not seen before, or to create customized teaching materials for different student groups or learner types that are tailored to a particular set of circumstances and progress levels in the subject in order to provide the specific level of challenge needed to achieve student engagement.

This example still involves deterministic content (in which there is a correct solution), but deterministic content that is impossible to analyze without a distributed computerized system (not necessarily because of its solution complexity, but because of the vastly complex set of contributing factors involved in making an accurate determination of difficulty).

In general, the disclosed technology can be used in various different scenarios to allow content providers of any kind to deliver objectively measured and rated content in situations for which objective measurement or rating through any non-computerized and non-distributed method would be otherwise impossible.

### III. Example Computing Environments

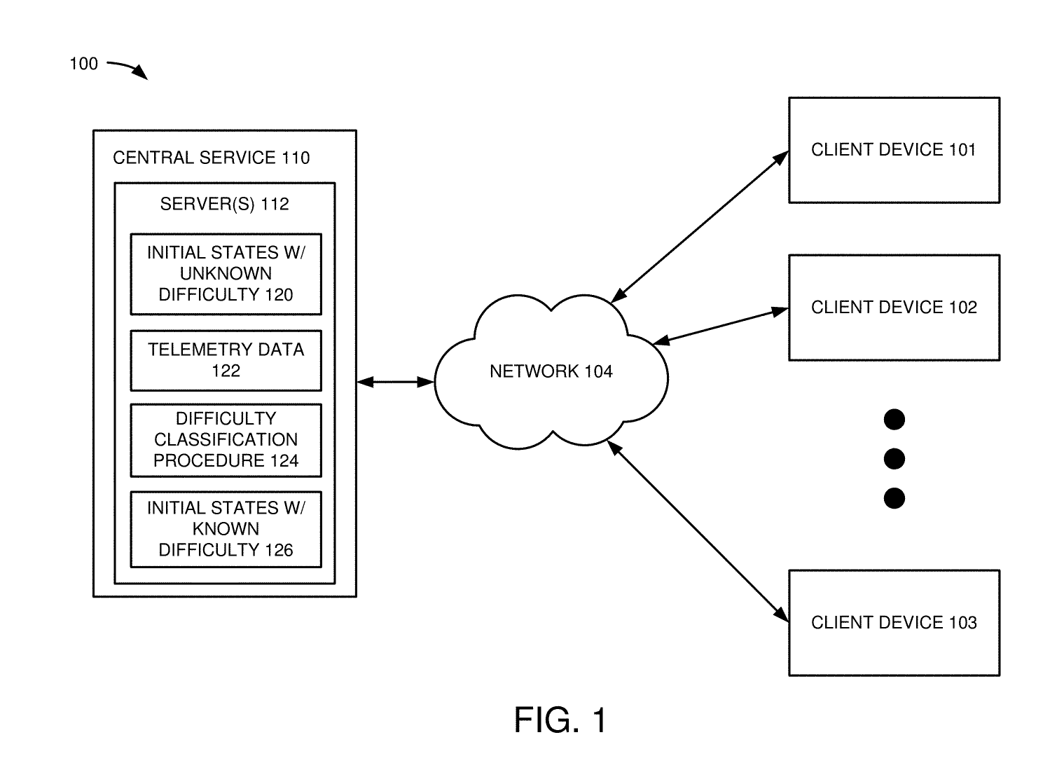

FIG. 1 is a schematic block diagram 100 of an example networked environment 100 in which embodiments of the disclosed technology can be implemented. In particular, environment 100 shows multiple user (client) devices 101, 102, 103 in communication with a central service 110 having one or more servers 112 via a network 104. The user devices 101, 102, 103 can be any of a variety of network-enabled computing devices (e.g., a mobile device, PC, laptop, tablet, or the like). In one embodiment, the network 104 comprises the internet, though other networks (e.g., a LAN or WAN) can also be used. The server(s) 112 can be cloud-based servers that are scalable “on demand” using various cloud technologies (such as the provisioning of virtual machines). Server(s) 112 can be configured to transmit data to and receive data from the user devices 101, 102, 103 and provide a variety of services that applications executing at the user devices 101, 102, 103 may invoke and use. As one example, server(s) 112 may serve a number of games to users operating the devices 101, 102, 103. One or more of those games may be deterministic initial-state-based games as discussed herein.

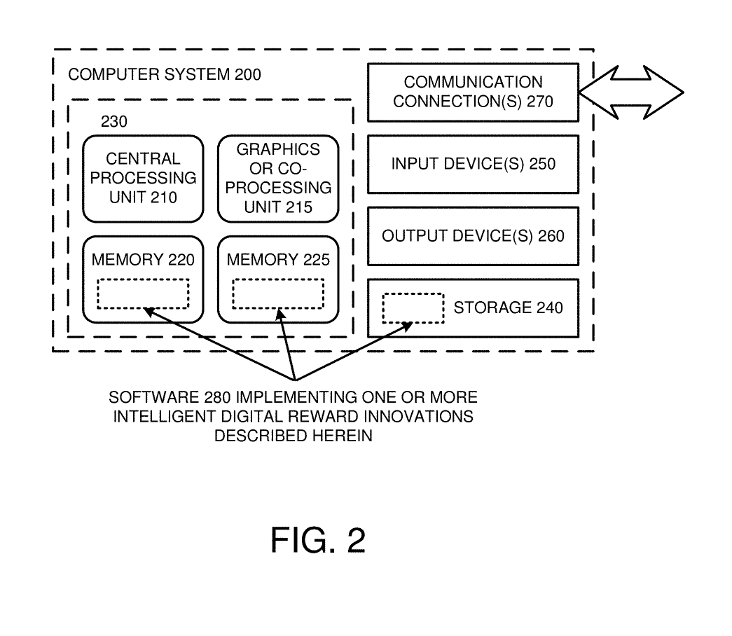

FIG. 2 illustrates a generalized example of a suitable computer system 200 in which the described innovations may be implemented. The example computer system 200 can be (or be part of) the one or more central servers 112 programmed to provide the functionality described herein. For instance, the server may be a server programmed to deliver content (e.g., initial state data or seeds) for and to receive telemetry data from a remote application executing at one or more of the computing devices 101, 102, 103. The example computer system 200 can also be (or be part of) a client system (such as any of client devices 101, 102 103) that is connected to the server (e.g., via the internet, LAN, WAN, or other connection). The client system can be, for example, a remote computing system executing an application, a web browser, a gaming console executing a game, or any other remote computing system.

With reference to FIG. 2, the computer system 200 includes one or more processing devices 210, 215 and memory 220, 225. The processing devices 210, 215 execute computer-executable instructions. A processing device can be a general-purpose CPU, GPU, processor in an ASIC, FPGA, or any other type of processor. In a multi-processing system, multiple processing units execute computer-executable instructions to increase processing power. For example, FIG. 2 shows a CPU 210 as well as a GPU or co-processing unit 215. The tangible memory 220, 225) may be volatile memory (e.g., registers, cache, RAM), non-volatile memory (e.g., ROM, EEPROM, flash memory, NVRAM, etc.), or some combination of the two, accessible by the processing device(s). The memory 220, 225 stores software 280 implementing one or more innovations described herein, in the form of computer-executable instructions suitable for execution by the processing device(s).

The computer system 200 may have additional features. For example, the computer system 200 includes storage 240, one or more input devices 250, one or more output devices 260, and one or more communication connections 270. An interconnection mechanism (not shown) such as a bus, controller, or network interconnects the components of the computer system 200. Typically, operating system software (not shown) provides an operating environment for other software executing in the computer system 200, and coordinates activities of the components of the computer system 200.

The tangible storage 240 may be removable or non-removable, and includes magnetic disks, magnetic tapes or cassettes, optical storage media such as CD-ROMs or DVDs, or any other medium which can be used to store information and which can be accessed within the computer system 200. The storage 240 stores instructions for the software 280 implementing one or more innovations described herein.

The input device(s) 250 may be a touch input device such as a keyboard, mouse, pen, or trackball, a voice input device, a scanning device, or another device that provides input to the computer system 200. For video or image input, the input device(s) 250 may be a camera, video card, TV tuner card, screen capture module, or similar device that accepts video input in analog or digital form, or a CD-ROM or CD-RW that reads video input into the computer system 200. The output device(s) 260 include a display device. The output device(s) may also include a printer, speaker, CD-writer, or another device that provides output from the computer system 200.

The communication connection(s) 270 enable communication over a communication medium to another computing entity. For example, the communication connection(s) 270 can connect the computer system 200 to the internet and provide the functionality described herein. The communication medium conveys information such as computer-executable instructions, audio or video input or output, image data, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations presented herein can be described in the general context of computer-readable media. Computer-readable media are any available tangible media that can be accessed within a computing environment. By way of example, and not limitation, with the computer system 200, computer-readable media include memory 220, 225, storage 240, and combinations of any of the above. As used herein, the term computer-readable media does not cover, encompass, or otherwise include carrier waves or signals per se.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or computer device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC such as an ASIC digital signal processor (“DSP”), a GPU, or a programmable logic device (“PLD”) such as a field programmable gate array (“FPGA”)) specially designed or configured to implement any of the disclosed methods.

### IV. Example Embodiments of Using Telemetry to Address Complex Problems

As noted, FIG. 1 is a schematic block diagram 100 of an example networked environment 100 in which embodiments of the disclosed technology can be implemented. As part of the services provided by the central service 100, the server(s) 112 can be configured to generate and distribute one or more initial states 120 for a game/puzzle/scenario having no known difficulty to the user devices 101, 102, 103. An initial state can be distributed, for example, when a user at one of the remote computing devices 101, 102, 103 chooses a “random” difficulty setting in the application being executed at the device, or, in some scenarios, when difficulty settings are not selectable. As more fully explained below, the server(s) 110 can thereafter collect telemetry data from the user devices 101, 102, 103 resulting from the user's interaction with the respective game/puzzle/scenario, and categorize the difficulty of the game/puzzle/scenario based at least in part on the collected telemetry data.

The one or more initial states 120 delivered by the server(s) can be in the form of a data structure that specifies the state of each element contributing to the initial state (e.g., a data structure specifying the particular cards, in order, of a standard 52-card deck). Such data structures may also be in the form of a “seed” that represents a compressed or encoded version of the initial state and that can be used by the application executing at the user devices 101, 102, 103 to determine the initial state by applying the seed to a specified “decoding” process that determines the initial state.

The one or more initial states 120 delivered by the server(s) can be randomly selected, pre-specified, or randomly selected from a set of possible initial states. For example, in some embodiments, a set of n initial states is selected (e.g., randomly selected) from a larger collection of possible initial states, where n is any desired integer value (e.g., 10, 25, 50, 100, 250, 500, or any other value). The set can then remain fixed until sufficient telemetry data is collected to perform an accurate difficulty classification for one or more of the initial states in the set, at which point the one or more of the initial states can be replaced with new initial states of unknown difficulty. A variety of mechanisms can be used to select which initial state from the set is to be transmitted to a computing device 101, 102, 103. For instance, the initial state may be randomly selected from the set, selected in a specified order, or selected based on some characteristic of the initial state (e.g., the initial state having the lowest (or relatively low) amount of telemetry data can be selected). Further, the central service 110 can track the destinations (e.g., using user IDs or device IDs) of the initial states 120 so that the same initial state is not repeatedly sent to the user (e.g., the service 110 can be configured to deliver a repeat seed only if no other non-repeat seeds are available)

The illustrated central service 110 is also configured to receive and store telemetry data 122 that includes data about particular games/puzzles played (or scenarios experienced) at the user devices 101, 102, 103; perform a difficulty classification procedure 124 (described in more detail below); and store and distribute the one or more initial states (or seeds) 126 for which a difficulty classification has been computed. For instance, the collection 126 of initial states having known difficulties can be used to select and deliver a particular initial state to a player selecting a particular difficulty level or as part of a “challenge” offered to player of a certain game/puzzle/scenario (such as a daily challenge, a weekly challenge, an event-oriented challenge, or any other offering where the difficulty of the game/puzzle/scenario is taken into account (either by the player or by the central services) prior to distribution).

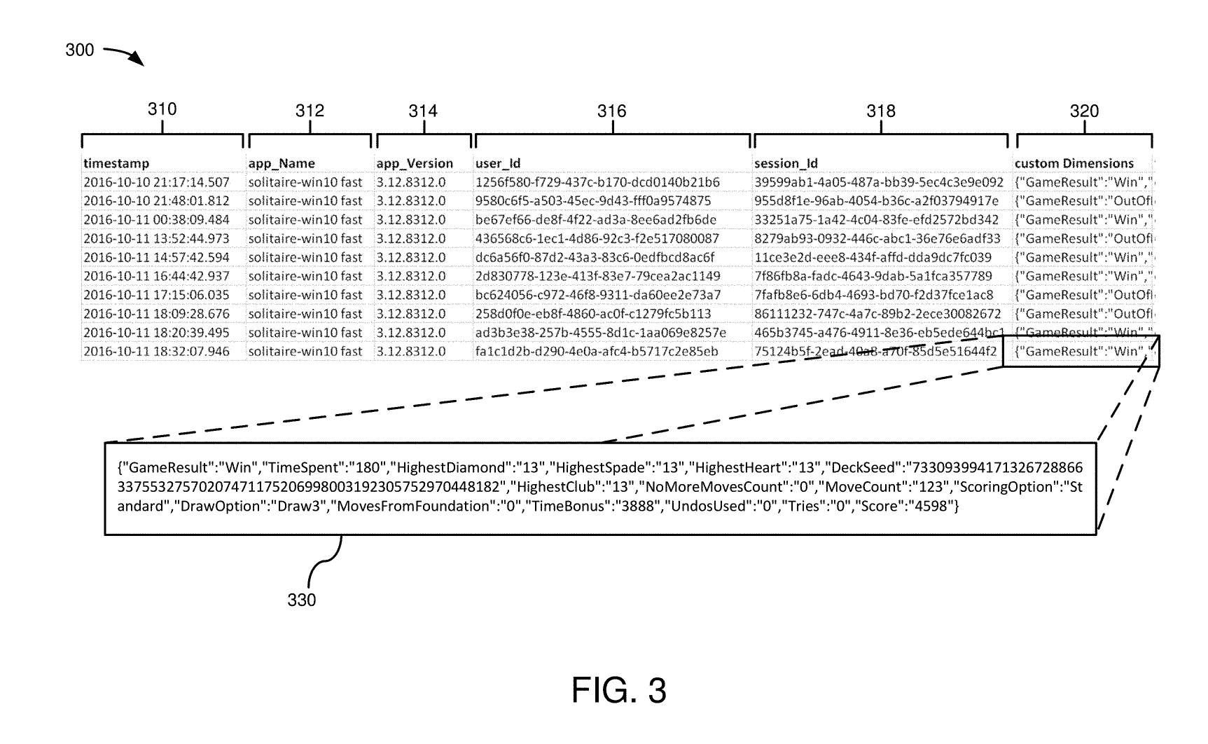

The telemetry data 122 can comprise a set of data (e.g., game data) that is transmitted from the user 101, 102, 103 when a game/puzzle/scenario has ended (or, in some embodiments, during game/puzzle/scenario execution, or both). FIG. 3 is a block diagram 300 illustrating an example set of game data collected for ten different plays of a game having a common initial state. The data can be generated, for example, by first transmitting the initial state to users at user devices 101, 102, 103, allowing the user to proceed with the game to completion (successful or not), and then receiving the game data when it is transmitted back to the central server (e.g., upon game completion). This example set of game data should not be construed as limiting in any way, as the game data can include less, more, or different types of data.

The example set of game data 300 can include one or more of: a time stamp 310 (e.g., identifying the specific time at which a game was originated or completed), an application name 312 (e.g., identifying the particular application to which the game data pertains), an application version number 314 (e.g., indicating the particular version number of the application), a user id 316 (e.g., identifying the user who played the game), an event or game name (e.g., identifying the particular game being played or application be executed at the user device), and/or a session id number 318 (e.g., identifying a particular unique game play “session” which may comprise one or more plays of a particular game or of games available through an application offering multiple games).

The set of game data 300 can also include detailed game play data indicative of a variety of game play details. As explained below, these game play details can be used to categorize a particular initial state into one of a plurality of difficulty categorizations. The detailed game play data can be customized for the particular game (or application), as each game or application may have unique game play characteristics that are indicative of player progress, difficulty of play, and/or player success. In the example set of game data 300, the detailed game play data is included in a customized field 320 labeled “custom dimensions”, though it should be understood that the data can be contained in separate individual fields as desired. As shown in expanded field 330, the detailed game play data can include one or more of: an indication of a game result, an initial-state identifier (e.g., a deck seed used to determine the shuffle of a 52-card deck), an indication of the number of moves performed, an indication of the number of “undos” used, an indication of the number of tries (e.g., the number of times a player selected to “retry” or “replay” the game/puzzle/scenario from the same initial state), an indication of the time spent playing the game from the initial state, and/or an indication of the score obtained by the player.

Additional game play data can also be monitored at the user device and transmitted to and collected by the central service 110. This additional game play data can be game specific data. For example, for Klondike Solitaire, game play data having unique meaning to Klondike Solitaire can be collected, such as the number of time the player hit the “no more moves” dialog (indicating that no more valid moves are available without the player “undoing” one or more moves), the number of moves from the foundation, the highest diamond achieved on the foundation, the highest club achieved on the foundation, the highest heart achieved on the foundation, the highest spade achieved on the foundation, and the like.

Table 1 below shows an example set of data fields (along with their possible values) that can be included in a set of game play data transmitted from a user device 101, 102, 103 to a central service 110 in accordance with embodiments of the disclosed technology. The particular data shown in Table 1 is customized for Klondike Solitaire, but can of course be altered, as appropriate, for any suitable game or puzzle or interactive scenario.

TABLE 1

| Field Name | Field Value | Description of Field Value |
|---|---|---|
| GameResult | Win | Board is completed |
| | NoMoreMoves | Player runs out of possible moves |
| | Abandoned | Player starts a new game without |
| | | either running out of moves or |
| | | completing the board. “User gave |
| | | up.” |
| DeckSeed | <variable> | The random seed for the game. |
| MoveCount | <variable> | Number of moves the player made - |
| | | this does not count moves that were |
| | | undone, only the unbroken chain of |
| | | moves from game start to the final |
| | | gamestate. |
| UndosUsed | <variable> | Number of times the player used the |
| | | Undo function in the current |
| | | playthrough. Using the [Undo Last |
| | | Move] button counts as an undo. |
| MovesFromFoundation | <variable> | Number of times the player moved a |
| | | card from the foundation onto the |
| | | tableau. Note that an undo of such a |
| | | move removes it form this count. |
| Tries | <variable> | 1 + the number of times the player |
| | | hit the [Try Again] button in the |
| | | Game over! screen. |
| | | This will require a running total to |
| | | be kept in the LocalState folder. |
| TimeSpent | <variable> | The total number of seconds elapsed |
| | | on the play clock at the final |
| | | gamestates of each try (each time |
| | | the game went to the Game over! |
| | | screen and hit the [Try Again] |
| | | button) |
| | | This will require a running total to |
| | | be kept in the LocalState folder. |
| NoMoreMovesCount | <variable> | Number of times the player hit the |
| | | fail dialog. |
| Score | <variable> | The score at the final gamestate |
| ScoringOption | Standard | Classic score method, default |
| | LasVegas | Vegas score method |
| | CumulativeVegas | Cumulative vegas scoring type |
| DrawOption | Draw1 | Used draw1 option |
| | Draw3 | Used draw3 option |
| TimeBonus | return (int)(700000/ | “Bonus scores that player earned |
| | Math.Max(1, | during game session.” Currently |
| | CardSupply.TimePlayed)); | supported by Klondike authority |
| | | when player had over 30 seconds |
| | | left on the timer. |
| HighestDiamond | 0-13 | Value of the highest Diamond in the |
| | | foundation (none = 0, A = 1, J = 11, |
| | | Q = 12, K = 13) |
| HighestClub | 0-13 | Value of the highest Club in the |
| | | foundation (none = 0, A = 1, J = 11, |
| | | Q = 12, K = 13) |
| HighestHeart | 0-13 | Value of the highest Heart in the |
| | | foundation (none = 0, A = 1, J = 11, |
| | | Q = 12, K = 13) |
| HighestSpade | 0-13 | Value of the highest Spade in the |
| | | foundation (none = 0, A = 1, J = 11, |
| | | Q = 12, K = 13) |

Having received and accumulated a plurality of sets of data (e.g., game data) from various player and for various initial states or seeds (shown as telemetry data 122 in FIG. 1), the central service 110 can implement a difficulty classification procedure (e.g., difficulty classification procedure 124). Example difficulty classification procedures are described in detail below.

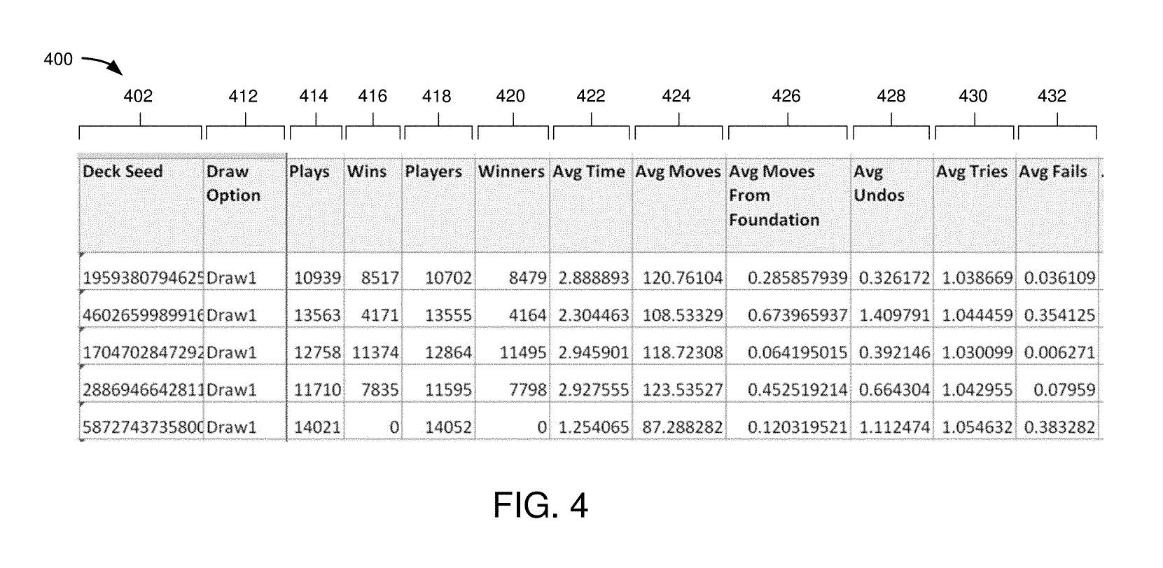

In particular embodiments, an accumulated database is maintained that inputs the data received and computes various metrics related to the data received that can then be used, at least in part, to categorize the initial states into one of a plurality of difficulty classifications. FIGS. 4-9 are block diagrams 400-900 of example game play metrics that can be included in the accumulated database. The particular fields and metrics shown in the examples should not be construed as limiting, as a wide variety metrics related to user interaction with a game/puzzle/scenario can be determined from the incoming data (e.g., game play data) transmitted from the various distributed user devices 101, 102, 103, including fewer, more, or different metrics than those shown. Also, any one or more metrics from FIGS. 4-9 can be included alone or in combination with any other one or more metrics from FIGS. 4-9 in the accumulated database.

As illustrated in FIG. 4, the illustrated accumulated database shows various game play metrics for respective initial states that were distributed to a large number of players (e.g., >1,000 players, >5000 players, >10,000 players, or any other sufficiently large number of players). The accumulated database 400 can include, for example, one or more of: an indication 402 of an initial state (e.g., an identification of the particular game seed used to determine the initial seed (here, for space reasons, the entire seed is not shown), an indication 412 of particular game options that could affect the difficulty experienced by the player (e.g., an identification of the “draw option” for the game, which either requires a player to draw 1 card at a time or 3 cards at a time from the “stock” pile); an indication 414 of the number of times the initial state was used (e.g., the number of games played from the initial state); an indication 416 of the number of times a player completed the objective for the corresponding initial state (e.g., the number of “wins” achieved by players for the initial state); an indication 418 of the number of unique players who played the game/puzzle/scenario starting from the corresponding initial state (the players may be less than the number of plays, as one player may try to complete the game/puzzle/scenario multiple times starting from the same initial state); an indication 420 of the unique number of players who completed the objective for the corresponding initial state (termed “winners”, whose number may be less than the number of wins as the same player may play the same initial state multiple times with success); an indication 422 of the average time for the game; an indication 424 of the average number of moves made by players during execution of the game; an indication 426 of the number of moves in which cards were moved from the foundation (thus indicating a non-intuitive move that provides an indication of the relative difficulty of the game, as it requires such non-intuitive moves to solve), an indication 428 of the average number of times the “undo move” selection was made (thus indicating that the player was faced with a “dead end” scenario requiring the player to back track to earlier states, and thereby correlating to game difficulty); an indication 430 of the average number of attempts or tries from the corresponding initial state; an indication 423 of the average number of fails (e.g., the number of time a player quit the game)

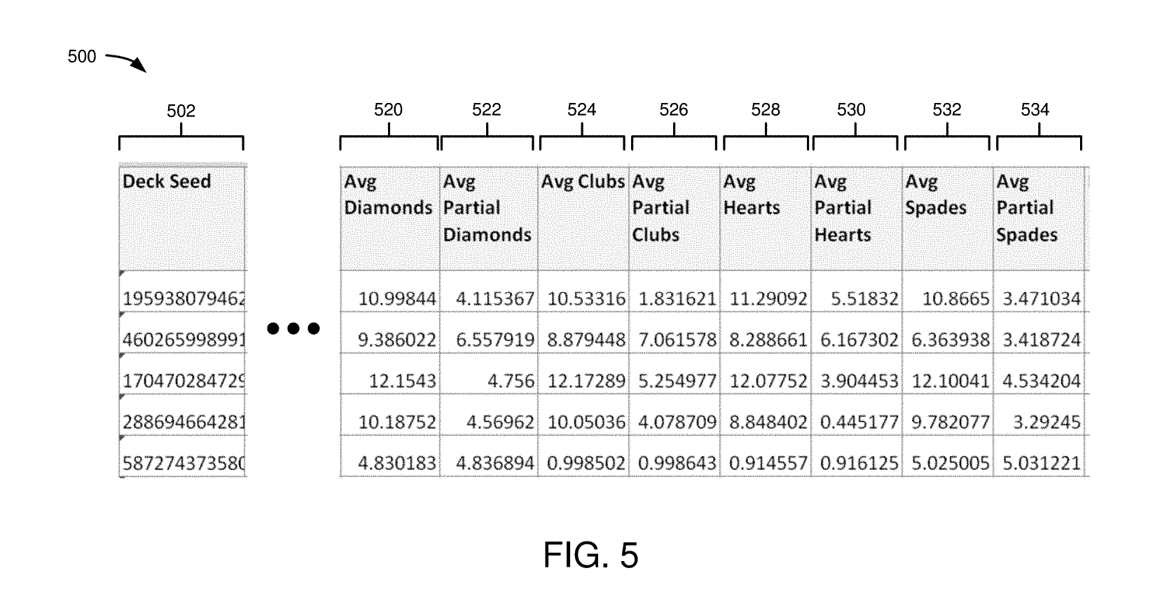

FIG. 5 is a block diagram 500 of additional game metrics that can be tracked and included as part of an accumulated database for particular initial states (or game seeds). In general, the game metrics of FIG. 5 are focused on metrics representative of the depth of play experienced by the users playing the example initial states. This depth-of-play data can be used as part of embodiments of the difficulty categorization processes disclosed herein. Although the metrics shown in FIG. 5 are unique to Klondike Solitaire, the underlying principles behind the data—specifically, the isolation and analysis of types of data that are indicative of difficulty—can be readily expanded to other data types.

Block diagram 500 comprises, for example, one or more of: an indication 502 of a particular initial state (expressed here as a unique seed corresponding to a unique initial state of a 52-card deck) along with additional detailed game play information that can be used as part of a difficulty classification process. In the illustrated example, the additional information includes one or more of: an indication 520 of the average value of the diamond suit placed on the foundation for all players (where cards are ranked from Ace to King with corresponding integer values of 1-13); an indication 522 of the average value of the diamond suit placed on the foundation for players who quit (thus the usage of the term “partial” in FIG. 5); an indication 524 of the average value of the clubs suit placed on the foundation for all players; an indication 526 of the average value of the clubs suit placed on the foundation for players who quit; an indication 528 of the average value of the hearts suit placed on the foundation for all players; an indication 530 of the average value of the hearts suit placed on the foundation for players who quit; an indication 532 of the average value of the spades suit placed on the foundation for all players; and/or an indication 534 of the average value of the spades suit placed on the foundation for players who quit.

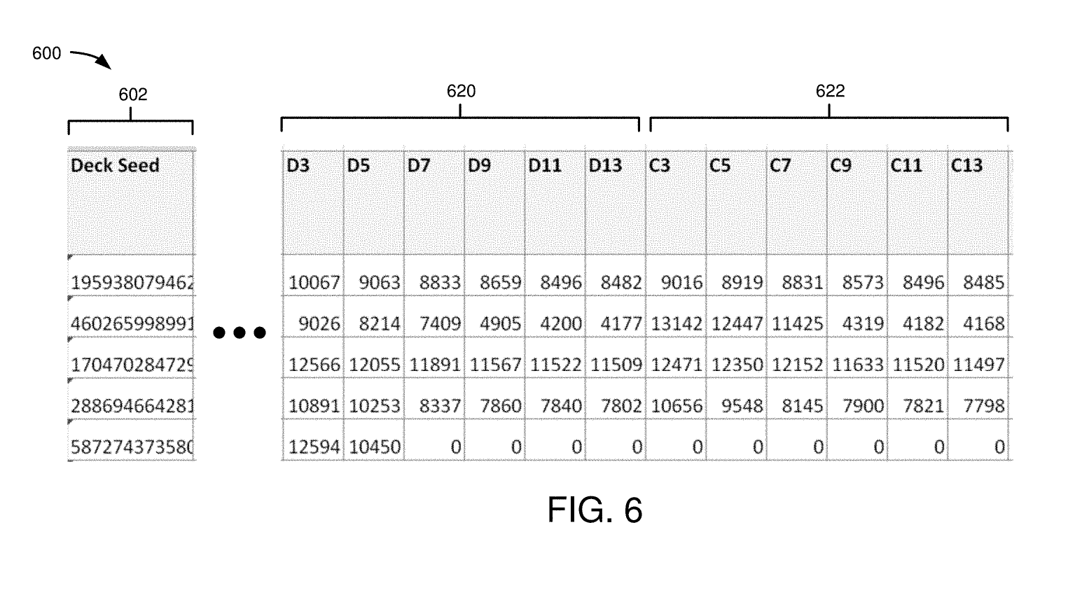

FIG. 6 is a block diagram 600 of additional game metrics that can be tracked and included as part of an accumulated database for particular initial states (or game seeds). As with FIG. 5, the game metrics of FIG. 6 are focused on metrics representative of the depth of play experienced by the users playing the example initial states. In FIG. 6, however, the game play data has finer granularity than in FIG. 5 and specifically focuses on particular results in the completion of the “foundation” in Klondike Solitaire, and therefore represents concrete, quantized data that is indicative of the progress toward game completion and that therefore correlates to game difficulty. This quantized depth-of-play data can be used as part of embodiments of the difficulty categorization processes disclosed herein. Although the metrics shown in FIG. 6 are unique to Klondike Solitaire, the underlying principles behind the data—specifically, the isolation and analysis of types of data that are indicative of difficulty and that quantize the game play data into parameters that provide analytically significant reference points—can be readily expanded to other data types.

Additionally, games such as Klondike Solitaire have the characteristic that the game can suddenly turn difficult for many players at certain points during the game. For instance, depending on the initial state, there may a series of cards in the tableau that provide a significant obstacle in proceeding further. The targeted data in FIG. 6 is useful in identifying how deep in the game such obstacles present themselves.

More specifically, FIG. 6 shows an indication 602 of a respective initial state (expressed here as a unique seed corresponding to a unique initial state of a 52-card deck) along with additional detailed game play information that can be used as part of a difficulty classification process. Further, FIG. 6 includes indications 620 of the number of players who were able to place a certain card onto the foundation for a particular suit, thereby indicating the number of players who were able to progress to various game milestones. In the illustrated example, fields 620 show the number of players who were able to place a 3 of diamonds (D3) onto the foundation, 5 of diamonds (D5) onto the foundation, 7 of diamonds (D7) onto the foundation, 9 of diamonds (D9) onto the foundation, Jack of diamonds (D11) onto the foundation, King of diamonds (D13) onto the foundation. Of course, this field may be expanded to include other values (D1 (the Ace of diamonds), D2, D4, D6, D8, D10, D12), reduced to include fewer values, or some combination thereof. Fields 622 show the number of players who were able to place those same cards to the foundation but from the clubs suit. Not shown are the corresponding values for the hearts and diamond suits, but it is to be understood that such data can also be collected.

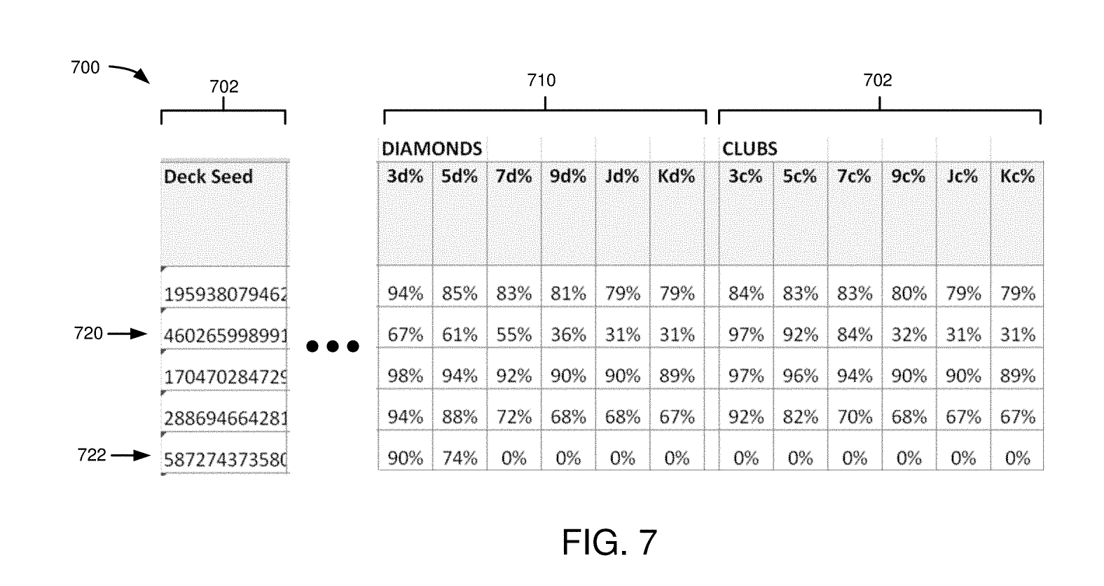

FIG. 7 is a block diagram 700 of how the raw data from FIG. 6 can be used to compute other useful metrics that are normalized in some fashion and can therefore be used more directly as part of difficulty classification. In particular, field 702 shows an indication of a respective initial state (expressed here as a unique seed corresponding to a unique initial state of a 52-card deck). Further, fields 710 show the percentage of players for the respective game seed who placed the identified value of diamond on the foundation (e.g., the number of players who placed the n of diamonds on the foundation/the total number of players). Such values can be determined from the raw data from FIGS. 4 and 6. Further, fields 712 show the percentage of players for the respective game seed who placed the identified value of clubs on the foundation (e.g., the number of players who placed the n of clubs on the foundation/the total number of players). Such values can be determined from the raw data from FIGS. 4 and 6. Although the other suits are not shown, it is to be understood that the data structure shown in FIG. 7 would typically include similar data from the other suits as well.

As noted, some games start as being relatively easy but turn difficult at some point during game play due to the initial state. The normalized data in FIG. 7 helps reveal such games more directly and can be used as part of a difficulty classification. Consider, for example, game seed 720 and a comparison between the percentage of players placing the 7 of clubs versus those placing the 9 of clubs on the foundation. The dropoff is significant and indicates that many players were able to play deep into the game but then were faced with an obstacle that most players could not overcome. Also consider game seed 722, where no player was able to place a 3 of clubs or higher to the foundation and which had a precipitous downturn in the percentage of players able to place diamonds to the foundation (as indicated by 90% for the 3 of diamonds, 74% for the 5 of diamonds, and 0% for the 7 of diamonds).

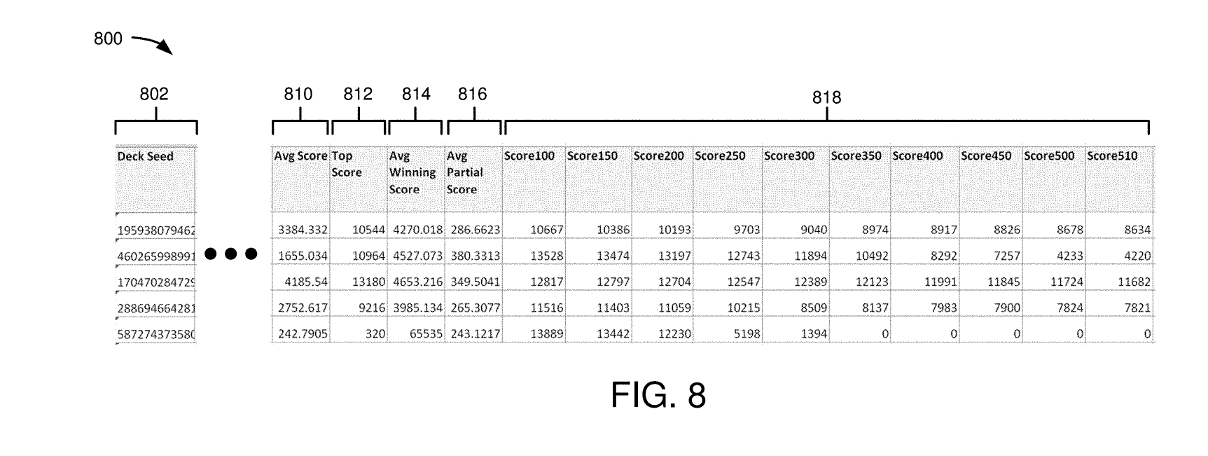

FIG. 8 is a block diagram 800 of additional game metrics that can be tracked and included as part of an accumulated database for particular initial states (or game seeds). As with FIG. 5, the game metrics of FIG. 8 are focused on metrics representative of the depth of play experienced by the users playing the example initial states. In particular, FIG. 8 shows various game metrics related to game score, where the scoring is in accordance with some standardized scoring methodology. In the illustrated embodiment, the scoring methodology is the standard scoring method for Klondike Solitaire, where a move from the draw pile to the tableau is scored as 5 points, a move to the foundation from either the draw pile or the tableau is scored as 10 minutes, turning over a card on the tableau is scored as 5, moving from the foundation back to the tableau is scored as −15 points. As noted elsewhere herein, the use of Klondike is by way of examples only, as other games/puzzles/scenarios can have other standardized scoring mechanisms. The score is another metric that represents concrete data indicative of the progress toward game completion and that therefore correlates to game difficulty.

More specifically, FIG. 8 shows a variety of different metrics related to score. In particular, field 802 shows an indication of a respective initial state (expressed here as a unique seed corresponding to a unique initial state of a 52-card deck). Field 810 shows the average score obtained across players of the corresponding deck seed. Field 812 shows the top score obtained from among the players of the corresponding deck seed. Field 814 shows the average score among those players who completed the game (the average winning score). Field 816 shows the average score among those players who did not complete that game (the average partial score). Fields 818, show the number of players from among the players who played the corresponding deck seed who reached certain specified milestone scores, here 100, 150, 200, 250, 300, 350, 400, 450, 500, 510. These milestone settings will vary from implementation to implementation but in general provide quantized data indicating how far players progressed in a game.

Additionally, and as noted above, games such as Klondike Solitaire have the characteristic that the game can suddenly turn difficult for many players at certain points during the game. The scoring data in FIG. 8 is useful in identifying how deep in the game such obstacles present themselves.

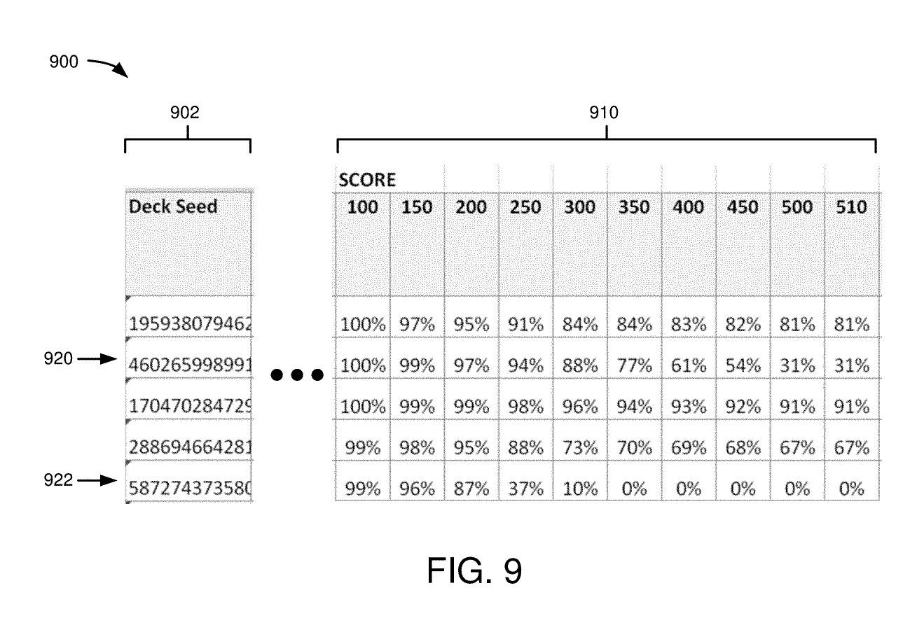

FIG. 9 is a block diagram 900 of how the raw data from FIG. 8 can be used to compute other useful metrics that are normalized and can therefore be used more directly as part of difficulty classification. In particular, field 902 shows an indication of a respective initial state (expressed here as a unique seed corresponding to a unique initial state of a 52-card deck). Fields 910 show the percentage of players for the respective game seed who reached the specified score (e.g., the number of players who reached score n/the total number of players). Such values can be determined from the raw data from FIGS. 4 and 8.

As noted, some games start as being relatively easy but turn difficult at some point during game play due to the initial state. The normalized data in FIG. 9 helps reveal such games more directly. Consider, for example, game seed 920 and a comparison between the percentage of players reaching scores of 400, 450, 500. The decline is substantial but occurs relatively deep in the game and does not drop to 0%. Also consider game seed 922, where nearly all players (87%) were able to reach a score of 200, but only 10% were able to reach a score of 300 and 0% were able to obtain a score of 350. The metrics of FIG. 9 are therefore indicative of depth of play and likelihood of success, and thus can be correlated to game difficulty.

Having described how telemetry data can be collected across a distributed computing network in numbers and detail sufficient to address otherwise NP complete problems, examples of how the data can be used to address particular problems will now be described.

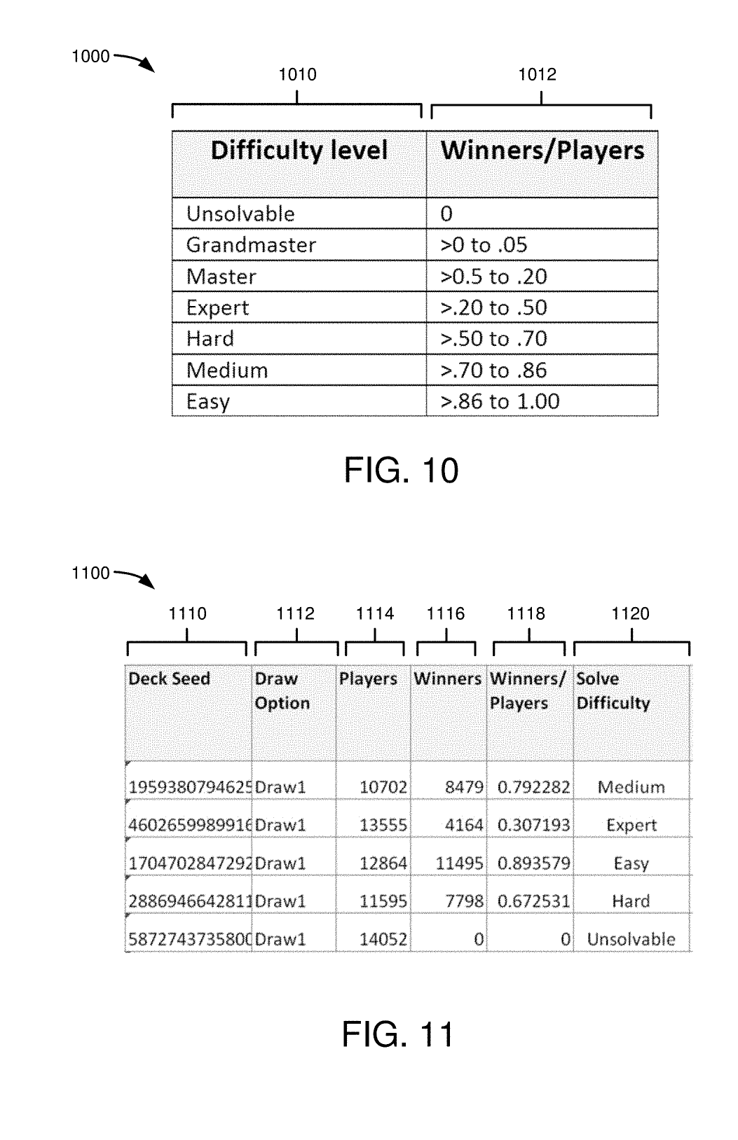

FIGS. 10 and 11 show one illustrative example for classifying game difficulty. The particular example shown in FIGS. 10 and 11 is with reference to Klondike solitaire, though the principles underlying the technique can be readily adapted to other games/puzzles/scenarios.

In the example embodiment illustrated by FIGS. 10 and 11, the game metric used for determining difficulty is the win percentage across all players for a respective initial state. In other words, the metric is the number of wins divided by the number of plays for a respective initial state. The resulting value is a fractional value descriptive of what percent of players were able to achieve a winning result.

In embodiments of the disclosed technology, a classification table (e.g., a look-up table, or other data structure defining corresponding difficulty levels (buckets) to matching metrics) is used to assign a respective difficulty level based on the relevant metric. The classification table can also be expressed as a set of rules that define the corresponding difficulty classifications and the conditions for meeting the classifications.

In FIG. 10, classification table 1000 specifies game-related difficulty levels, but in other embodiments, the difficulty levels are related to any given scenario in which difficulty levels are desirably assigned (e.g., educational problems, or other scenarios where it is desirable to distribute problems/initial states/seeds/etc. to a large number of users in order to more objectively determine the difficulty of the problem/initial state/seed/etc.). In the example shown in FIG. 10, the classification table 1000 identifies seven distinct game difficulty levels: unsolvable, grandmaster, master, expert, hard, medium, and easy. It should be understood that this number and characterization is by way of example only as any number of difficulty levels and classification titles can be used. Specifically, field 1010 of FIG. 10 identifies the title for the difficulty level, and field 1012 specifies a range of game metric values for assigning the respective classification title.

FIG. 11 is a block diagram illustrating a data structure 1100 showing the results of applying the classification table of FIG. 10 to example deck seeds, resulting in difficulty categorizations for each respective deck seed. In particular, data structure 1100 includes field 1110 indicating the respective deck seed. Field 1112 indicates the draw style for which the corresponding data was selected (here, draw 1 means that cards from the draw pile are overturned one at a time (as opposed to the other recognized option: three at a time)). Field 1114 indicates the number of players of the identified seed for which data was collected. Field 1116 indicates the number of winners of the identified seed (the number of players that completed the game by reaching the game's objective). Field 1118 is derived from fields 1114 and 1116 and shows the number of winners/the number of players (the percentage of players who were able to reach the game's objective). The values from field 1118 are then applied to the classification table 1000 of FIG. 10 to determine the difficulty classification for the respective seeds. Field 1120 shows the resulting difficulty classification.

The particular normalized metric shown in FIGS. 10 and 11—namely, “winners/players”—is by way of example only, as a variety of other metrics that are indicative of game difficulty can be used in embodiments of the disclosed technology. For example, any of the following can be used as a suitable metric that correlates to game difficulty: average time of game play (for either or both of completed games or uncompleted games), average number of moves made by players (for either or both of completed games or uncompleted games), average number of times a “non-intuitive” game play move was made (e.g., for Klondike Solitaire, this can be the average number of times moves were made from the foundation (which is legal but not widely known or used), average number of times a user selected a mechanism to undo one or more previous moves (e.g., the average number of “undos” or “wind backs”), the average number of times the users tried (or retried) to complete the game from a selected initial state, the average number of fails (e.g., the number of times players failed over the number of plays (which is effectively the corollary to the wins/plays metric), the average number of milestones reached—where the milestones are game events or achievements that occur as a player progresses toward game completion—for either or both of completed games or uncompleted games (e.g., for Klondike Solitaire or the like, this can be the average card value of a particular suit placed on the foundation, as shown in FIG. 5), the number or percentile of plays that resulted in a particular milestone being reached (e.g., for Klondike Solitaire or the like, this can be any of the values shown in FIGS. 6 and 7), the average score obtained, the top score, the average score obtained among completed plays, the average score obtained among players uncompleted plays, the number or percentile of plays that resulted in a particular scoring milestone being reached (e.g., for Klondike Solitaire or the like, this can be any of the values shown in FIGS. 8 and 9), and/or the number of wins divided by the number of plays.

Further, metrics can be adjusted to discount anomalous data. For instance, one or more conditions or filters can be applied that must be satisfied before the telemetry data is considered reliable for use in any metric. For instance, all data relating to games that were only played for a suspiciously short or long amount of time can be ignored. For instance, a filter can be applied that removes data whose time of play was less than some minimum value or greater than some maximum value. The actual settings, of course, will vary depending on the game. Additionally, filters for removing or ignoring particular users or other types of suspicious users can be applied.

Still further, although only a single metric is used in the example of FIGS. 10 and 11, it should be understood that multiple metrics can be used. Such multiple metrics can be part of some weighted formula and/or as part of some conditional formulation. For instance, any suitable metric can be combined with one or more other metrics to arrive at a combined metric that may add precision to the determination of difficulty classification. Such a combined metric may be weighted to favor one metric over another. For instance, the following general weighted formulation may be used:

(weight₁×metric₁)+(weight₂×metric₂) . . . +(weightₙ×metricₙ)=combined metric,

where the “weight” values can correspond to a weight (e.g., between 0 and 1), and the metric values can correspond to any of the metrics disclosed herein such that they can be readily applied to a standardized difficulty classification table (e.g., metrics that have been normalized across the pool of users (such as by averaging, computing percentiles, or the like)).

Additionally, conditional formulations can be used to apply the metrics as part of a difficulty classification. For instance, any Boolean operation (e.g., AND, OR, NOT, or other such operation) can be used to generate a formulation for evaluating depth of play for a specified initial state.

Still further, formulations that account for rates of changes between metrics can be used as part of a difficulty classification procedure. For example, a formulation that accounts for the rate of change between a first milestone and a second milestone (where the milestones are consecutive in order during user interaction with the game/puzzle/scenario) can be used to identify rapid changes in progress that can be used to identify relative difficulties.

Additionally, formulations that account for the account information, play history, achievement level, and/or past situational performance of the player(s) can be used as part of a difficulty classification procedure. For example, a formulation that accounts for a player's history of playing “expert-level” content could be used to filter players whose play patterns might be considered highly advanced in order to exclude, include, and/or weight their data as part of the determination (depending on the purpose of that determination).

Further, the difficulty classification process can be conditional on some threshold number of players being presented with an unclassified initial state/seed (e.g., a game seed of an unknown difficulty), thus preventing difficulty attribution based on only a small and unreliable pool of data. For instance, the threshold can be 100 players (or plays), 500 players (or plays), 1000 players (or plays), 5000 players (or plays), 10,000 players (or plays), or any other suitably high value that reduces the inaccurate influence of over-skilled (or under-skilled) players in arriving at a proper difficulty classification that accounts for players of all skill sets. By using a deep pool of telemetry data from a variety of users, the subjective influence of the individual users can be significantly reduced and a more objective difficulty classification computed.

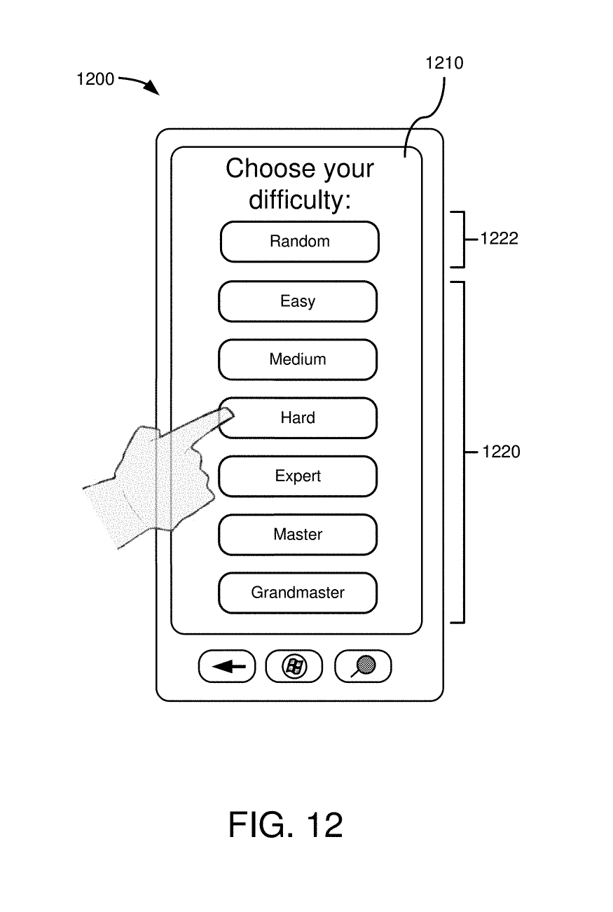

Once the initial states of the game/puzzle/scenario have been classified according to difficulty, the initial states can be added to a database of initial states having known difficulties. The initial states can then be used as part of the presentation to allow a player to choose a desired difficulty. FIG. 12 is a schematic block diagram 1200 illustrating one example difficulty selection screen 1210 as may be presented to a user as part of execution of a game/puzzle/scenario and which controls the interaction with the central server. The difficulty selection screen 1210 includes user interface buttons 1220 for selecting a particular difficulty but also includes a user interface button 1222 for selecting a random difficulty. The random difficulty can be, for example, a randomly selected seed from among seeds of unknown difficulty or a seed randomly selected from among seeds of known difficulty.

The results of the game/puzzle/scenario from any of the selections can then be returned to the central server for use in a difficulty determination as described or to refine pre-existing difficulty determinations. For example, the selection of a random difficulty can be effectively used to generate and collect user interaction data from across a distributed group of players. The user interaction data can then be used, as shown and described herein, to categorize the difficulty of a particular initial state or seed.

### V. General Embodiments

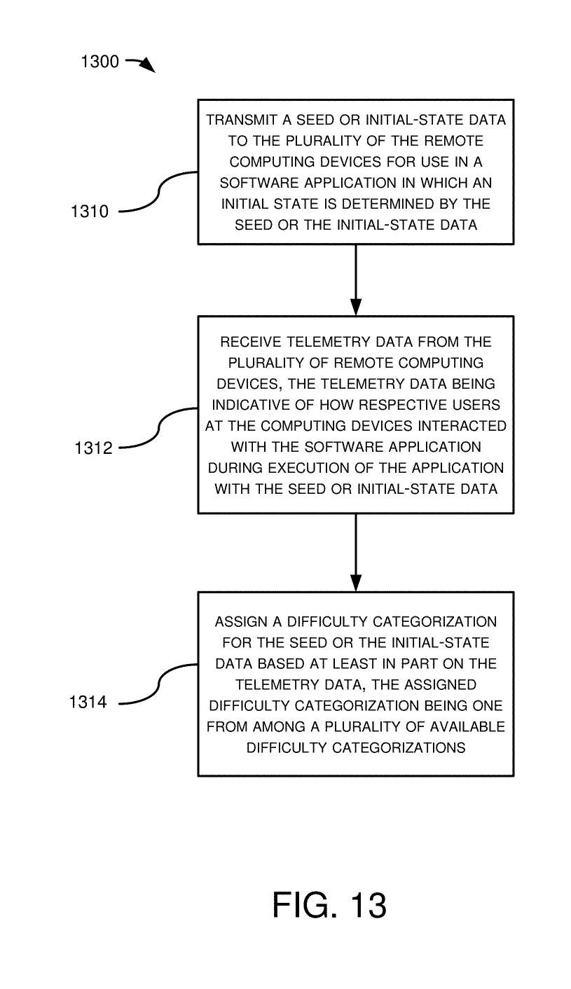

FIG. 13 is a flow chart 1300 showing one example method for classifying difficulty of a game/puzzle/scenario using embodiments of the disclosed technology. In FIG. 13, the method is performed by a central server for a plurality of remote client computing devices (e.g., a remote computer connected to the central server via the internet). The remote client computing device can be a mobile device, personal computer, laptop computer, tablet computer, gaming console, or the like. Any of the disclosed methods or method acts can be performed with any other methods or method acts disclosed herein.

At 1310, a seed or initial-state data is transmitted to the plurality of the remote computing devices for use in a software application in which an initial state is determined by the seed or the initial-state data. In particular embodiments, the software application provides an interaction that begins from an initial state determined from the seed or initial-state data and thereafter proceeds until completion of an objective or failure to reach the objective (e.g., without further modification from the central server). For instance, the software application can be for playing a “solitaire”-style game in which, after the initial state is set, the outcome is determined from player decisions alone. In particular applications, the seed or initial-state data can be used to determine the order of cards in a deck of cards (e.g., a standardized and specific card deck, such as a standard 52-card deck). Further, in some examples, the seed or the initial-state data is of an unknown difficulty level. In some embodiments, the seed or initial-state data is randomly selected from a set of seeds or initial-state data having an unknown difficulty. For instance, a set of seeds or initial-state data can be randomly generated, and then used as the “pool” from which the seeds or initial-state data is selected and then transmitted to the remote computing devices. The set can have any desired sized (e.g., 100 seeds, 500 seeds, 1,000 seeds, or any other value). This way, substantial telemetry data can be collected for each seed or initial state (as opposed to always randomly selecting a seed or an initial state, in which case gathering multiple instances of telemetry data may be difficult due to the large number of possible initial states).

At 1312, telemetry data is received (e.g., input, buffered into memory, stored, and/or otherwise prepared for further processing) from the plurality of remote computing devices, the telemetry data being indicative of how respective users at the computing devices interacted with the software application during execution of the application with the seed or initial-state data. For instance, the telemetry can be any of the data described herein (e.g., any of the data in Table 1) or, more generally, can comprise data indicative of progress made by a user of the respective remote computing device toward completion of an objective for a game/puzzle/scenario that began from the initial state determined from the transmitted seed or initial-state data. For instance, the telemetry data received can comprise an identification of the seed (or the initial-state data) and an indication of a result, the result being one of an indication that the game/puzzle/scenario was completed or an indication that the game/puzzle/scenario was not completed. In other cases, the telemetry data can also comprise an identification of the seed (or the initial-state data) and an indication of a result, the result being one of an indication that the game/puzzle/scenario was completed, that the game/puzzle/scenario was abandoned, or that the game/puzzle/scenario reached a point where no more progress was possible. In some cases, the telemetry data received comprises an identification of the seed (or the initial-state data) and an indication of one or more of a score achieved or a number of moves made. In further cases, the telemetry data received comprises data indicating whether or not one or more milestones reached by the user in the game/puzzle/scenario. The milestones can be milestones toward completion of an objective (e.g., one or more specified scores, one or more specified cards placed on the foundation, one or more intermediate objectives reached), and thus indicate how deep the user was able to play (e.g., how much progress the user was able to make toward the objective). As noted, the number of remote computing devices from which telemetry data is received can be large (e.g., >100, >500, >1000, or >10,000), thus allowing significant amounts of telemetry data to be collected from a broad network of distributed resources. By using data collected from a large number of sources, complex problems that are typically viewed as subjective (such as solvability difficulty) can be addressed in a fashion that improves the accuracy and objectivity of the final determination.

At 1314, a difficulty categorization is assigned for the seed or the initial-state data based at least in part on the telemetry data, the assigned difficulty categorization being one from among a plurality of available difficulty categorizations. In some embodiments, the assigning of the difficulty categorization comprises: computing a difficulty-indicative data element from the telemetry data; applying the difficulty-indicative data element to a difficulty categorization table defining two or more difficulties to respective ranges of the difficulty-indicative element; and assigning the difficulty categorization based on the application of the difficulty-indicative data element to the difficulty categorization table. In some embodiments, the assigning the difficulty categorization comprises: computing a difficulty-indicative data element for telemetry data for a plurality of seeds or initial-state data, the difficulty-indicative data being normalized to provide a common metric for the telemetry data that reduces effects from the seed or the initial-state data being used by different numbers of users at the plurality of the remote computing devices. In particular implementations, for example, the difficulty-indicative data element is related to a particular game and is derived from a total number of winners and the total number of players who played the game from the corresponding initial state or seed. More generally, the difficulty-indicative data element can be derived from the total number of users who successfully completed an objective (e.g., for a game/puzzle/scenario) for a corresponding initial state or seed and the total number of users who attempted to complete the objective for the corresponding initial state or seed.

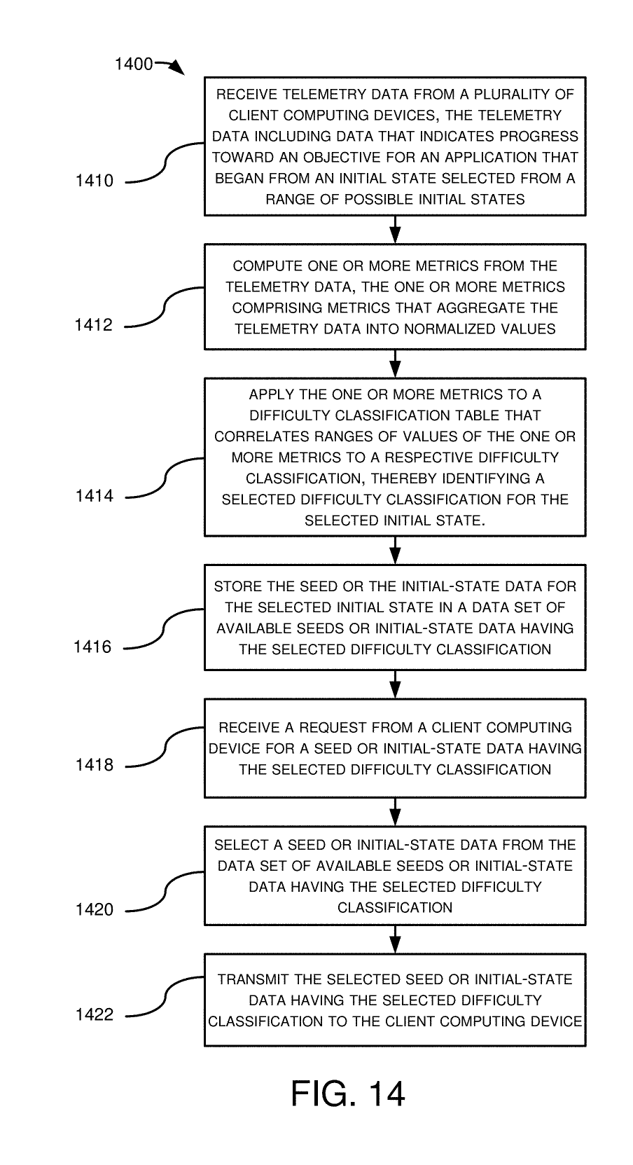

FIG. 14 is a flow chart 1400 showing another example method for classifying difficulty of a game/puzzle/scenario using embodiments of the disclosed technology. In FIG. 14, the method is performed by a central server for a plurality of remote client computing devices (e.g., a remote computer connected to the central server via the interna). The remote client computing device can be a mobile device, personal computer, laptop computer, tablet computer, gaming console, or the like. Any of the disclosed methods or method acts can be performed with any other methods or method acts disclosed herein.

At 1410, telemetry data from a plurality of client computing devices is received (e.g., input, buffered into memory, stored, and/or otherwise prepared for further processing), the telemetry data including data that indicates progress toward an objective made by a user at a respective client computing device for an application that began from an initial state selected from a range of possible initial states, the selected initial state being determined from a seed value or an initial-state value. As noted, the number of remote computing devices from which telemetry data is received can be large (e.g., >100, >500, >1000, or >10,000), thus allowing significant amounts of telemetry data to be collected from a broad network of distributed resources. By using data collected from a large number of sources, complex problems that are typically viewed as subjective (such as solvability difficulty) can be addressed in a fashion that improves the accuracy and objectivity of the final determination. Further, the technical solutions described herein have particular application to situations where the range of possible initial states is large (e.g., >1×10¹⁰) and/or where the problem is influenced by variable skill, making it subjective in nature.

At 1412, one or more metrics are computed from the telemetry data, the one or more metrics comprising metrics that aggregate the telemetry data into normalized values.

At 1414, the one or more metrics are applied to a difficulty classification table that correlates ranges of values of the one or more metrics to a respective difficulty classification. The process results in a selected difficulty classification being identified for the selected initial state.

At 1416, the seed or the initial-state data is stored in a data set of available seeds or initial-state data having the selected difficulty classification.

At 1418, a request is received from a client computing device for a seed or initial-state data having the selected difficulty classification.

At 1420, a seed or initial-state data is selected from the data set of available seeds or initial-state data having the selected difficulty classification.

At 1422, the selected seed or initial-state data having the selected difficulty classification is transmitted to the client computing device.

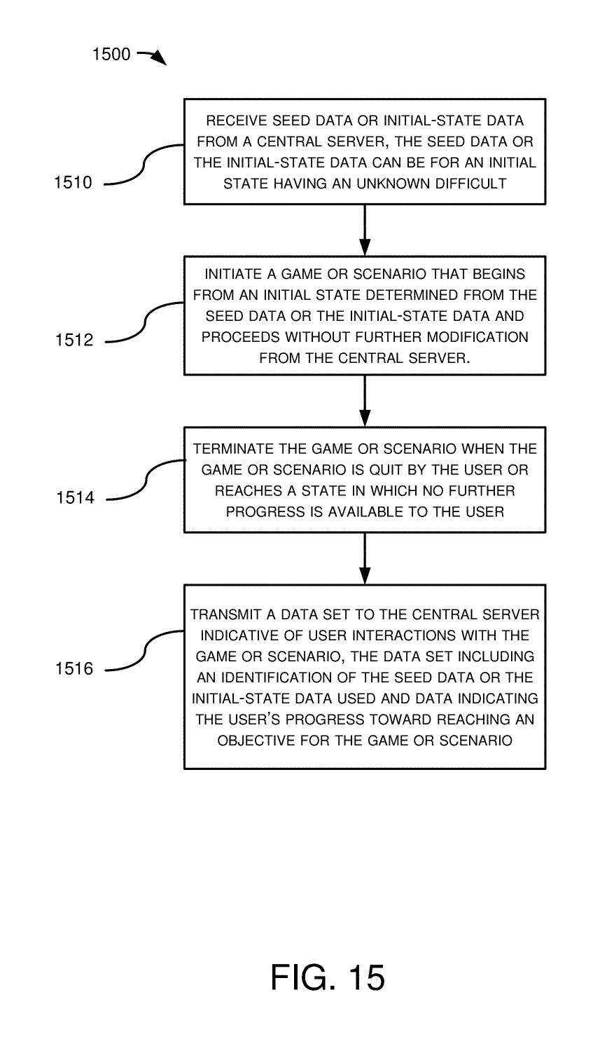

FIG. 15 is a flow chart 1500 showing another example method for implementing the disclosed technology. In FIG. 15, the method is performed by a remote computing device in communication with a central server (e.g., via the internet). The remote client computing device can be a mobile device, personal computer, laptop computer, tablet computer, gaming console, or the like. Any of the disclosed methods or method acts can be performed with any other methods or method acts disclosed herein.

At 1510, seed data or initial-state data is received (e.g., input, buffered into memory, stored, and/or otherwise prepared for further processing) from the central server. The seed data or the initial-state data can be for an initial state of unknown difficulty.

At 1512, a game or scenario is initiated. The game or scenario begins from an initial state determined from the seed data or the initial-state data and proceeds without further modification from the central server. For instance, the game or scenario can be a “solitaire”-style game or scenario in which, after the initial state is set, the outcome is determined from player decisions alone (e.g., there are no in-game characters or obstacles with programmed behaviors that can affect game outcome).

At 1514, the game or scenario when the game or scenario is quit by the user or reaches a state in which no further progress is available to the user.

At 1516, a data set is transmitted to the central server indicative of user interactions with the game or scenario. The data set can include, for example, an identification of the seed data or the initial-state data used and data indicating the user's progress toward reaching an objective for the game or scenario.

In certain examples, the game or scenario can be a first game or scenario, and the remote client computing device can be further programmed to: allow the user to select a difficulty categorization for a subsequent game or scenario; and receive, from the central server, seed data or initial-state data for the subsequent game. In this example, the seed data or initial-state data for the subsequent game can be assigned the selected difficulty categorization based at least in part on data sets received by the central server from multiple remote client computing devices indicating progress made by users of the multiple remote client computing devices toward reaching the objective for the game or scenario for the subsequent game seed data or initial-state data.

### VI. Concluding Remarks

In view of the many possible embodiments to which the principles of the disclosed invention may be applied, it should be recognized that the illustrated embodiments are only preferred examples of the invention and should not be taken as limiting the scope of the invention.

What is claimed is:

1. A method, comprising:
by a central server in communication with a distributed plurality of remote computing devices via a network:
transmitting a seed or initial-state data to the distributed plurality of the remote computing devices for use in a software application in which an initial state is determined by the seed or the initial-state data;
receiving telemetry data from the distributed plurality of remote computing devices, the telemetry data being indicative of how respective users at the computing devices interacted with the software application during execution of the application with the seed or initial-state data; and
assigning a difficulty categorization for the seed or the initial-state data based at least in part on the telemetry data, the assigned difficulty categorization being one from among a plurality of available difficulty categorizations.

2. The method of claim 1, wherein the software application provides an interaction that begins from an initial state determined from the seed or initial-state data and thereafter proceeds until completion of an objective or failure to reach the objective without further modification from the central server.

3. The method of claim 1, wherein the seed or the initial-state data is of an unknown difficulty.

4. The method of claim 1, wherein the seed or the initial-state data is randomly selected from among a plurality of seeds or initial-state data.

5. The method of claim 1, wherein the telemetry data received comprises an identification of the seed or the initial-state data and an indication of a result, the result being one of an indication that a game or scenario provided by the software application was completed or an indication that the game or scenario provided by the software application was not completed.

6. The method of claim 1, wherein the telemetry data received comprises an identification of the seed or the initial-state data and an indication of a result, the result being one of an indication that a game or scenario provided by the software application was completed, that the game or scenario provided by the software application was abandoned, or that the game or scenario provided by the software application reached a point where no more progress was possible.

7. The method of claim 1, wherein the telemetry data received comprises an indication of one or more of a score achieved or a number of moves made.

8. The method of claim 1, wherein the telemetry data received comprises an indication of whether one or more milestones in progression toward achieving an objective were reached.

9. The method of claim 1, wherein the assigning a difficulty categorization comprises:
computing a difficulty-indicative data element from the telemetry data; and
applying the difficulty-indicative data element to a difficulty categorization table defining two or more difficulties to respective ranges of the difficulty-indicative element; and
assigning the difficulty categorization based on the application of the difficulty-indicative data element to the difficulty categorization table.

10. The method of claim 9, wherein the assigning the difficulty categorization comprises:
computing a difficulty-indicative data element for telemetry data for a plurality of seeds or initial-state data, the difficulty-indicative data being normalized to provide a common metric for the telemetry data that reduces effects from the seed or the initial-state data being used by different numbers of users at the plurality of the remote computing devices.

11. The method of claim 9, wherein the difficulty-indicative data element is derived from a total number of users who successfully completed an objection and a total number of users who attempted to complete the objective.

12. The method of claim 1, wherein the plurality of remote computing devices comprises 1000 or more remote computing devices.

13. A system, comprising:
a client computing device comprising a memory and one or more processors, the one or more processors being programmed to:
receive, from a central server, seed data or initial-state data;
initiate a game or scenario that begins from an initial state determined from the seed data or the initial-state data and that proceeds without further modification from the central server;
terminate the game or scenario when the game or scenario is quit by the user or reaches a state in which no further progress is available to the user; and
transmit a data set to the central server indicative of user interactions with the game or scenario, the data set including an identification of the seed data or the initial-state data used and data indicating the user's progress toward reaching an objective for the game or scenario.

14. The system of claim 13, wherein the seed data or the initial-state data is for a game or scenario of unknown difficulty.

15. The system of claim 13, wherein the game or scenario is a first game or scenario, and wherein the one or more processors are further programmed to:
allow the user to select a difficulty categorization for a subsequent game or scenario; and
receive, from the central server, seed data or initial-state data for the subsequent game or scenario, the seed data or initial-state data for the subsequent game or scenario having been assigned the selected difficulty categorization based at least in part on data sets received by the central server from multiple remote client computing devices indicating progress made by users of the multiple remote client computing devices toward reaching the objective for the game or scenario for the subsequent seed data or initial-state data.

16. One or more computer-readable media storing computer-executable instructions, which when executed by a computer cause the computer to perform a method, the method comprising:
receiving telemetry data from a plurality of client computing devices, the telemetry data including data that indicates progress toward an objective made by a user at a respective client computing device for an application that began from an initial state selected from a range of possible initial states, the selected initial state being determined from a seed value or an initial-state value;
computing one or more metrics from the telemetry data, the one or more metrics comprising metrics that aggregate the telemetry data into normalized values;
applying the one or more metrics to a difficulty classification table that correlates ranges of values of the one or more metrics to a respective difficulty classifications, the applying resulting in a selected difficulty classification being identified for the selected initial state; and
storing the seed or the initial-state data in a data set of available seeds or initial-state data having the selected difficulty classification.

17. The one or more computer-readable media of claim 16, wherein the method further comprises:
after the applying, receiving a request from a client computing device for a seed or initial-state data having the selected difficulty classification;
selecting a seed or initial-state data from the data set of available seeds or initial-state data having the selected difficulty classification; and
transmitting the selected seed or initial-state data having the selected difficulty classification to the client computing device.

18. The one or more computer-readable media of claim 16, wherein the plurality of client computing device comprises 100 or more client computing devices.

19. The one or more computer-readable media of claim 16, wherein the initial state corresponds to a unique shuffle of a standardized deck of cards.

20. The one or more computer-readable media of claim 16, wherein the range of possible initial states is larger than 1×10¹⁰.
